(19) United States
(12) Patent Application Publication
(10) Pub. No.: US 2009/0125484 A1
(43) Pub. Date: May 14, 2009

(54) System and method for engaging an online employment service

(76) Inventor: John P. Carrieri, San Diego, CA (US)

Correspondence Address: INTELLETECH, PLLC, 501 SIXTH STREET, N.E., SUITE 700, WASHINGTON, DC, 20002-5205, US

(21) Appl. No.: 12/215,072

(22) Filed: Jun. 25, 2008

Related U.S. Application Data
(60) Provisional application No. 60/929,368, filed on Jun. 25, 2007.

(51) Int. Cl. G06F 7/06; G06F 17/30

(52) U.S. Cl. 707/3; 707/E17.108

(57) ABSTRACT

An online employment website and the computer system and software for operating the website are disclosed. The invention relates to a system and method for gathering information from both employers and job applicants, and providing an online database management system that screens the applicants so that an employer is charged for a particular job listing only if an applicant meets specified criteria for that particular job.

### CROSS-REFERENCE TO RELATED APPLICATIONS

This application is related to and claims the benefit of prior-filed U.S. Provisional Application for Patent Ser. No. 60/929,368, filed on 25 Jun. 2007, entitled “SYSTEM AND METHOD FOR ENGAGING AN ONLINE EMPLOYMENT SERVICE,” which is incorporated herein by reference.

### FIELD OF THE INVENTION

The present invention relates to an online employment website and the computer system and software for operating the website. In particular, the invention relates to a system and method for gathering information from employers and job applicants, and screening the applicants so that an employer is charged for a particular job listing only if an applicant meets specified criteria for that particular job.

### BACKGROUND OF THE INVENTION

The number and variety of goods and services available by computer via the Internet and World Wide Web is vast and growing daily. Furthermore, rapidly expanding access to high-speed broadband service is making shopping, searching and communicating over the Internet the default choice for personal and business use. Indeed, for hundreds of millions of users around the world, Internet use may now be a daily activity. Many goods and services that formerly were marketed through print, television or brick-and-mortar media are now primarily conducted via the Internet.

In particular, businesses in the information services industry, such as dating, real estate and education, have developed highly successful online presences. Employment services are another prime example. Supplanting the traditional methods of newspaper classified ads, magazine or television ads, or word of mouth, recruiting websites now make available an enormous number of positions, from virtually any geographic area, in real time. Job seekers typically can search job listings and submit résumés online 24/7.

Examples of popular commercial employment websites include CareerBuilder.com®, Dice.com®, Monster.com®, Yahoo!® HotJobs® and many others. According to the International Association of Employment Web Sites (IAEWS), the trade association for the global online employment services industry, such services are also provided by newspapers; radio and television stations; trade and professional magazines and publications; professional associations and societies; college, university, and trade/technical school alumni organizations; and affinity groups. The IAEWS noted in 2007 that there were more than 40,000 employment sites worldwide that serve job seekers, employers and recruiters.

While the existing commercial employment websites may provide valuable services to their employer, job seeker and recruiter constituents, nonetheless there are inadequacies in the typical business model for such sites. In particular, when an employer wishes to advertize a job on an online site, the standard payment arrangement is that the employer pays a fixed fee for the posting. Typical costs in 2007 for commercial employment website range from about $299 to about $459 for one job listing. Some websites that recruit from entry-level applicant pools, such as CollegeRecruiter.com, may charge as little as $175 per job listing. For an employer who lists a job and receives no prospective employee matches, however, the investment is for naught.

The present invention provides a commercial online employment service with an innovative pricing model that both reduces the cost of posting a job listing and also eliminates the risk that an employer pays for a job listing without receiving any applicants for that listing. Instead of charging an up-front fee to an employer for listing a job, as is typical for online employment services, the present invention collects additional information in both the employee and employer databases. That information is used to screen applicants for posted jobs. Employers provide information for several “criteria,” that if satisfied by the applicant, trigger the system to submit the applicant for the posted job, and also trigger a charge to the employer for the job listing. As well, applicants provide information that correlates to the various criteria. For example, the employer may require that an applicant have 7-10 years of work experience. The present invention screens all applicants for the job, matches only those applicants who meet that criterion, i.e., have 7-10 years of work experience (and who also meet any other criteria specified by the employer), submits only those matching applicants to the employer, and then and only then, charges the employer for the job listing.

The employment criteria that are used by the present invention to screen and match applicants to job may include, but are not limited to, years of experience (termed “experience level” herein), stage in career (termed “career level” herein), education/degree achieved (termed “education level” herein), certification and/or license held (termed “certification and license” herein), and miles from job (termed “proximity” herein). It is contemplated by the present invention that screening criteria may be added to or removed, as employers' needs, conditions and the times change.

As described above, each criterion comprises a range of values. The employer preferably specifies the level required for a particular job. In another innovation of the present invention, the employer may consult the website to review the statistics on prospective employees, and, if the employer has no matches (i.e., no applicants meet the specified criterion or criteria), then the employer may reduce the level required for the job, in order to attract a wider applicant pool. Similarly, if the employer finds it is receiving far too many qualified applicants, it may raise the level of that or other criteria.

The present invention also contemplates a sliding scale of fees for matching the employer with qualified applicant. For an applicant closer to entry level (years of experience, career level, educational level, or the like), the fee charged to the employer for the job listing preferably is lower. For a highly skilled position, where the applicant is required to have many years of experience (or a high level of education, such as a Ph.D., or other skill), the fee charged to the employer preferably is higher. This is yet another aspect of the present invention that delivers superior value to the customer (the employer).

Various online employment systems are known in the art, for example U.S. Pat. No. 5,832,497 to Taylor discloses a system for posting job advertisements that includes a search mechanism and allows applicants to submit résumés and apply for jobs online. Similarly, U.S. Pat. No. 6,662,194 to Joao discloses a method and apparatus for providing recruitment information via a computerized network such at the Internet or other communications network. U.S. Pat. No. 7,251,658 to Dane et al. discloses a résumé database system that allows communication between multiple users. In addition, U.S. Pat. No. 7,099,872 to Carpenter et al. discloses a method of managing employment data that provides access via the Internet, uses information spidering to collect and update employment data, matches the updated employment data with an employer's criteria, and contacts the employer regarding the match.

None of these known systems, however, utilizes the innovative cost model of the present invention that screens and matches applicants to particular jobs, whose requirements are selected by the employer, and then charges the employer only for successful matches.

Additional objects and advantages of the invention are set forth, in part, in the description which follows and, in part, will be apparent to one of ordinary skill in the art from the description and/or from the practice of the invention.

### SUMMARY OF THE INVENTION

In response to the foregoing challenge, Applicant has developed an innovative and cost effective system and method for engaging an online employment service. As embodied herein, the computer-implemented system for engaging an online employment service comprises a database management system that assesses at least one employee attribute from at least one prospective employee and at least one employment criterion from at least one prospective employer, wherein the database management system produces a job match when the at least one employee attribute matches the at least one employment criterion. The invention further comprises a screening process for triggering a fee to the at least one employer only after the job match results.

The computer-implemented system of the present invention further comprises a first online database for accepting the at least one employee attribute from the at least one prospective employee, and a second online database for accepting the at least one employment criterion from the at least one prospective employer. The present invention may further comprise a notification system for informing the at least one prospective employee and the at least one prospective employer of the job match.

The at least one employee attribute may further comprise employee personal information, years of experience, military experience, previous employment, education, languages, résumé, certification and licenses, security clearances, employment goals, relocation considerations, felony convictions and work status.

The at least one employer criterion may further comprise employer information, job characteristics, location of job, job type, salary range, proximity to employee zip code, years of experience, career, level, education level and certification and licenses.

In addition, the screening process may trigger a subsequent fee to the at least one employer after each subsequent result of the job match between the at least one employee attribute and the at least one employment criterion. Further, said at least one prospective employee may comprise a plurality of prospective employees and said at least one prospective employer may. comprise a plurality of prospective employers.

The computer-implemented system of the present invention may further comprise the hardware and software necessary to operate the first database for accepting the at least one employee attribute, the second database for accepting the at least one employment criterion, the database management system for assessing the at least one employee attribute and the at least one employment criterion in order to produce the job match, the screening process for triggering the fee, and the notification system for informing the at least one prospective employee and the at least one prospective employer of the job match.

The present invention of a computer-implemented method for engaging an online employment service may comprise the steps of accepting at least one employee attribute from at least one prospective employee into a first online database, accepting at least one employment criterion from at least one prospective employer into a second online database, assessing the at least one employee attribute and the at least one employment criterion with an online database management system, producing a job match when the at least one employee attribute matches the at least one employment criterion, screening the job match so as to trigger a fee to the at least one employer only after the job match results, and notifying the at least one prospective employee and the at least one prospective employer of the job match.

The at least one employee attribute of the computer-implemented method may further comprise employee personal information, years of experience, military experience, previous employment, education, languages, résumé, certification and licenses, security clearances, employment goals, relocation considerations, felony convictions and work status.

The at least one employer criterion of the computer-implemented method may further comprise employer information, job characteristics, location of job, job type, salary range, proximity to employee zip code, years of experience, career level, education level and certification and licenses.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

FIG. 1 is a flowchart depicting a system and method of providing an online employment service known in the prior art.

FIG. 2 is a flowchart depicting a system and method of engaging an online employment service according to an embodiment of the present invention.

FIG. 3 is a diagram of the software architecture according to an embodiment of the present invention.

FIG. 4 is a diagram of the architecture headings for information categories according to an embodiment of the present invention.

FIG. 5 is a screen print of the home page showing the Employment Search and Job Search screen according to an embodiment of the present invention.

FIG. 6 is a screen print of the Post Resume and Job Seeker Login screen according to an embodiment of the present invention.

FIG. 7 is a screen print of the Employee Logged In screen according to an embodiment of the present invention.

FIG. 8a is a screen print of the first page of the Employee Account Setup screen according to an embodiment of the present invention.

FIG. 8b is a screen print of the Resume Setup screen, the second page of the Employee Account Setup, according to an embodiment of the present invention.

FIG. 9 is a screen print of the result of a Job Search of a particular job listing by a qualified applicant, showing the active Apply button according to an embodiment of the present invention.

FIG. 10 is a screen print of the result of qualified applicant's applying for a particular job, showing that the application has been sent according to an embodiment of the present invention.

FIG. 11 is a screen print of Applicant Detail, the information submitted to an employer by the applicant in order to apply for a particular job according to an embodiment of the present invention.

FIG. 12 is a screen print of the Employer Sign Up and Login screen according to an embodiment of the present invention.

FIG. 13 is a screen print of the Employer Account Setup screen according to an embodiment of the present invention.

FIG. 14 is a screen print of Employer Logged In, showing a screen with Post A Job, Job Manager, Applicant Manager and Edit Profile buttons according to an embodiment of the present invention.

FIG. 15 is a screen print of the Employer Post A Job screen according to an embodiment of the present invention.

FIG. 16 is a screen print of the Employer Job Manager screen according to an embodiment of the present invention.

FIG. 17 is a screen print of the Employer Applicant Manager screen according to an embodiment of the present invention.

FIG. 18 is a screen print of the Employer Applicants List screen according to an embodiment of the present invention.

FIG. 19 is a screen print of the Employer Account Stats and Edit Profile screen according to an embodiment of the present invention.

### DETAILED DESCRIPTION OF THE INVENTION

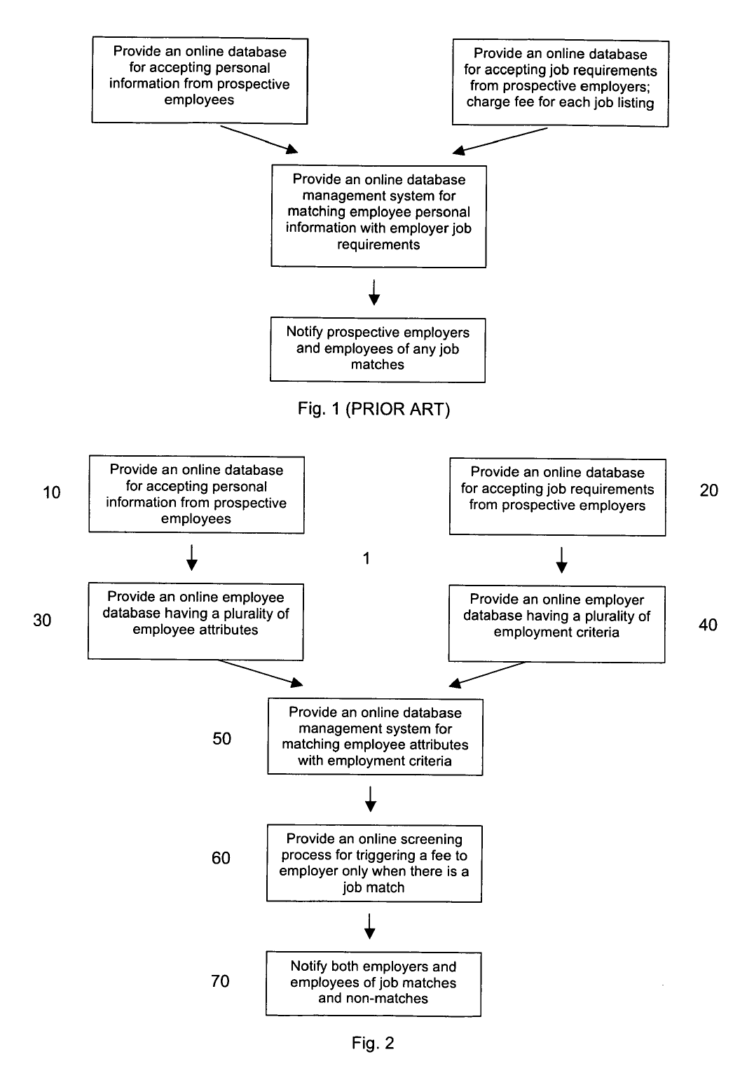

Referring now to FIG. 1, a flowchart of prior art online employment services is shown. The prior art services typically use a business model for pricing that charges an up-front fee to a prospective employer for each job listing, regardless of whether any applicants are ever matched to that listing.

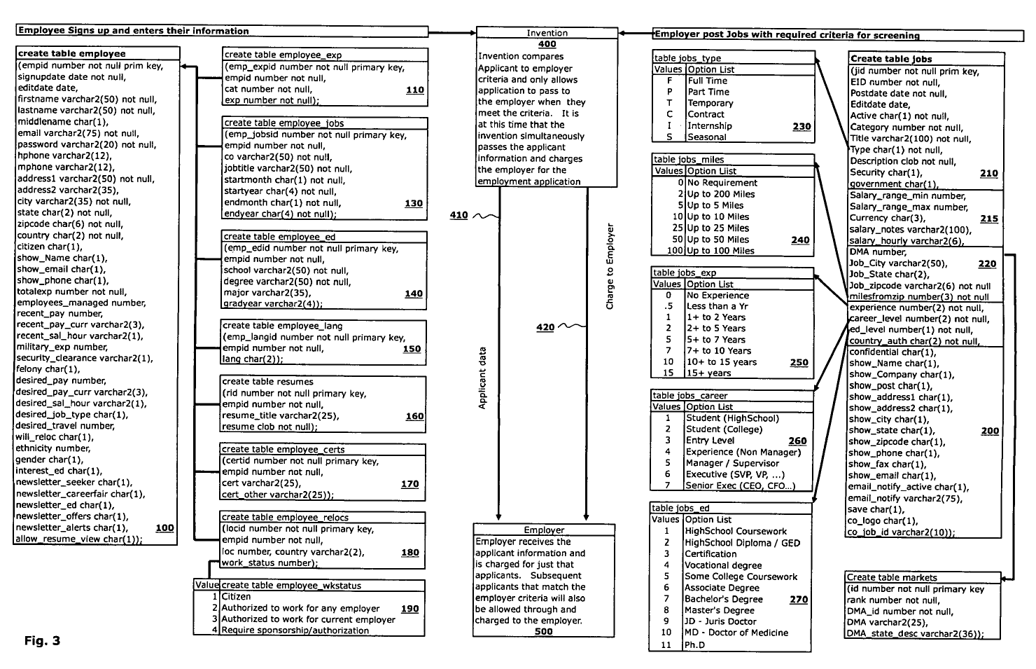

Referring now to FIG. 2, a flow chart of a preferred embodiment of the present invention is shown. The system and method of engaging an online employment service is shown as 1. System and method 1 preferably comprises a first step of providing an online database 10 for accepting personal information from prospective employees (“employee” is used herein interchangeably with “applicant” and “job seeker”). System and method 1 also preferably comprises a second step of providing an online database 20 for accepting job requirements from prospective employers.

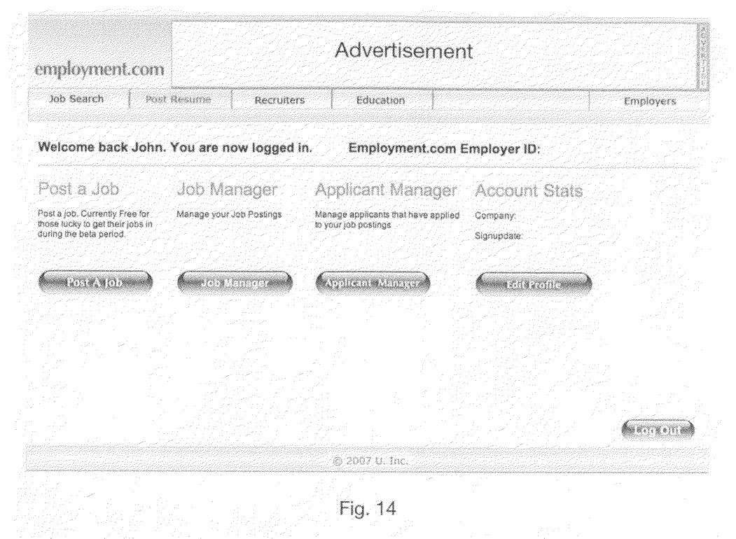

The present invention further comprises a third step of providing online employee database 10 with a plurality of employee attributes 30, and a fourth step of providing online employer database 20 with a plurality of employment criteria 40. System and method 1 preferably comprises a fifth step of providing an online database management system 50 for matching employee attributes 30 with employment criteria 40. The present invention further comprises a sixth step of providing an online screening process 60 for triggering a fee to an employer only when there is a job match between employment criteria 40 and employee attributes 30. As embodied herein, system and method 1 preferably comprises a seventh step of providing a notification process 70 for informing both employers and applicants of both job matches and non-matches. Notification process 70 may include sending an email message to the employer that an applicant has applied for a particular job. Alternatively, that information may be available from the website via the Applicant Manager screen (as shown in FIGS. 14, 17 and 18). Notification process 70 may also include sending an email message to the applicant that he/she has either been accepted for or rejected from the application process for a particular job.

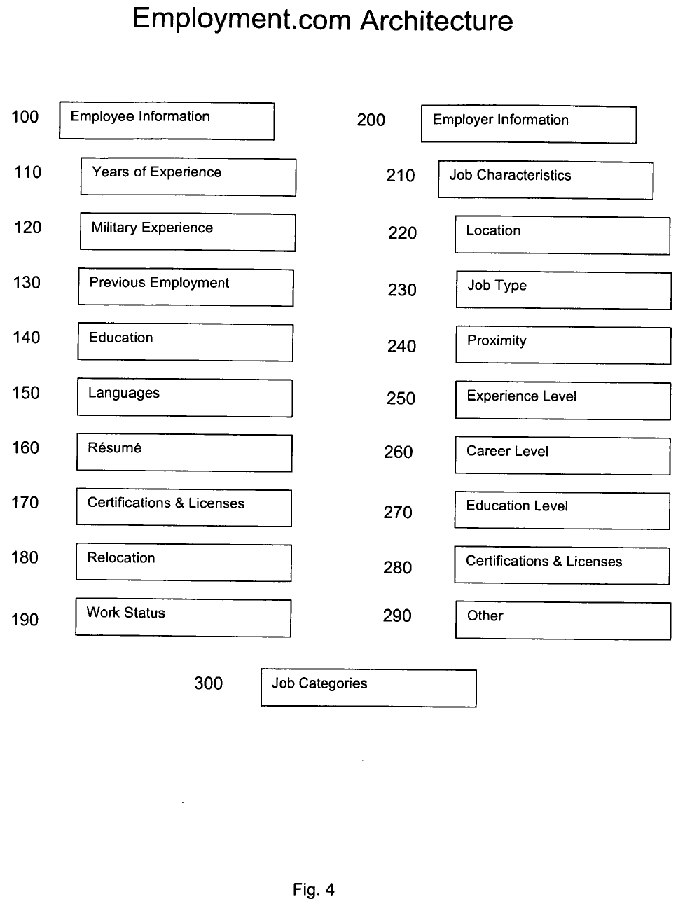

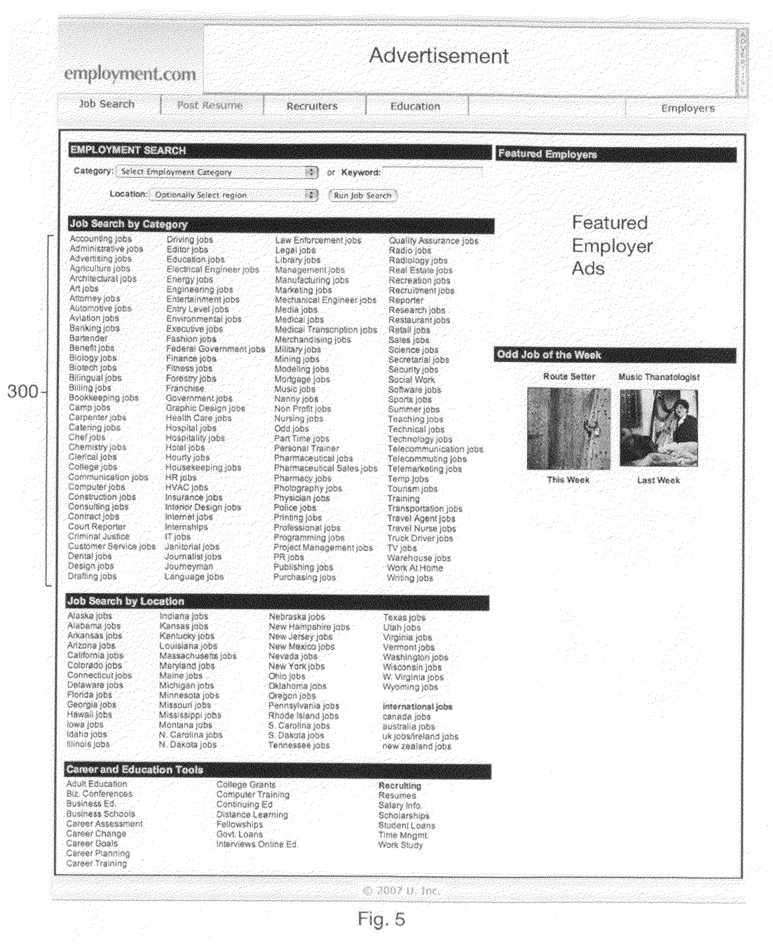

Referring now to FIGS. 3 and 4, the software architecture for a system and method of engaging an online employment service 1 is shown. The step of providing a plurality of employee attributes 30 further comprises the step of providing the following categories of employee information 100 or attributes: years of experience 110, military experience 120, previous employment 130, education 140, languages 150, résumé 160, certifications and licenses 170, relocation preferences 180, and work status 190.

With continuing reference to FIGS. 3 and 4, the step of providing a plurality of employment criteria 40 further comprises the step of providing the following categories of employer information 200 and job characteristics 210: salary 215, location 220, job type 230, proximity to place of employment 240, experience level 250, career level 260, education level 270, certifications and licenses 280, and other (unspecified category) 290.

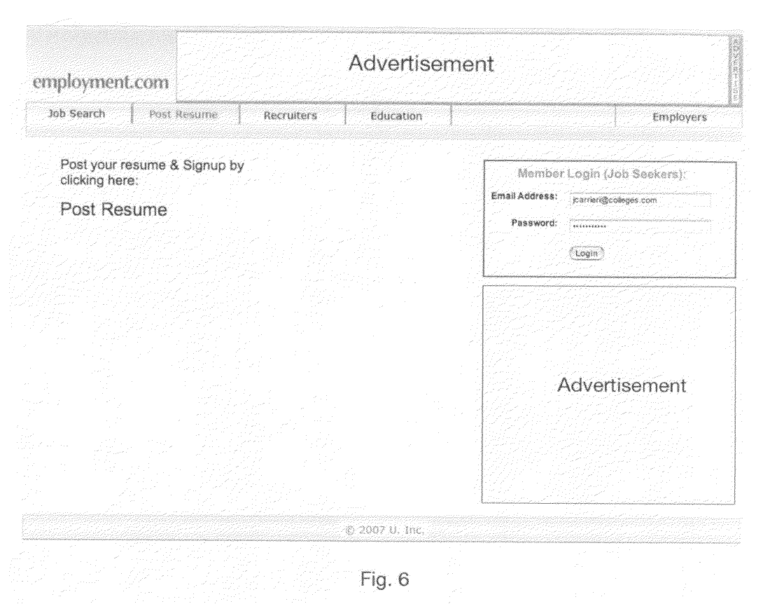

With continuing reference to FIG. 4 and as shown in FIG. 5, system and method of engaging an online employment service 1 further comprises the step of providing a list of job categories 300 for which positions are available.

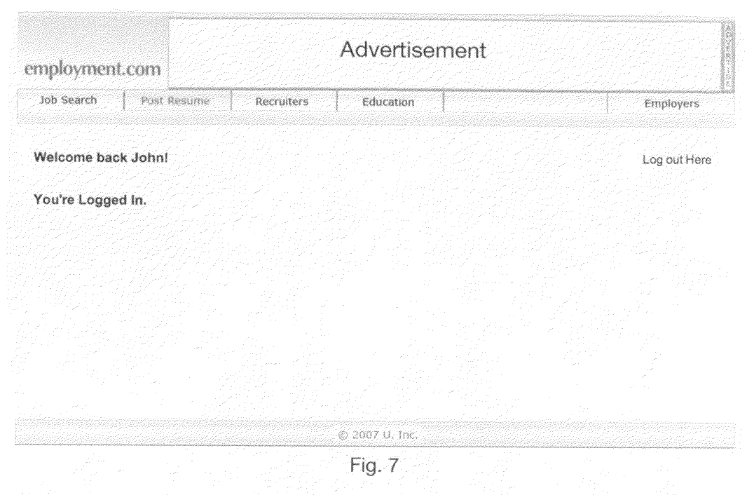

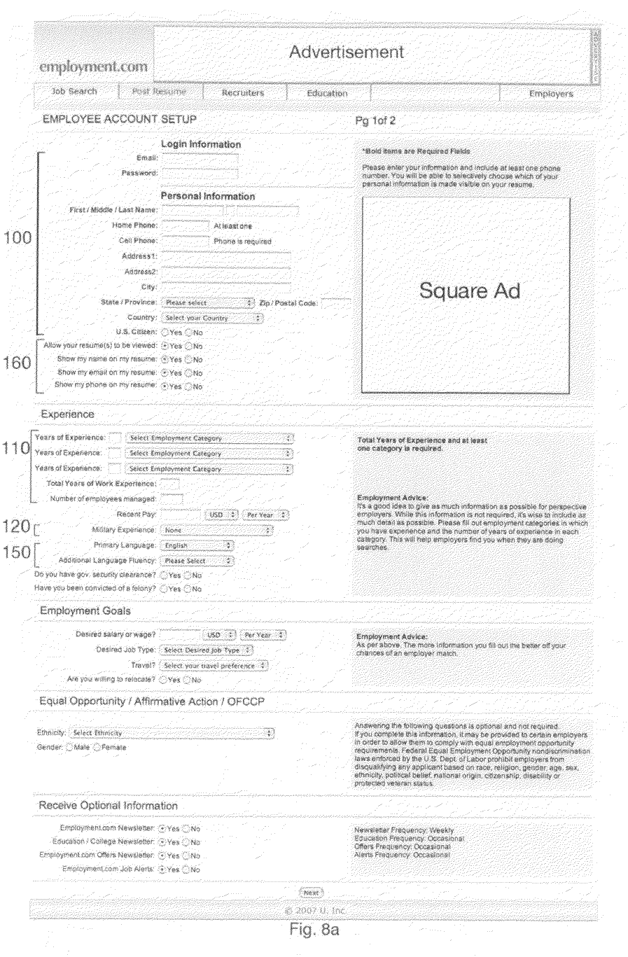

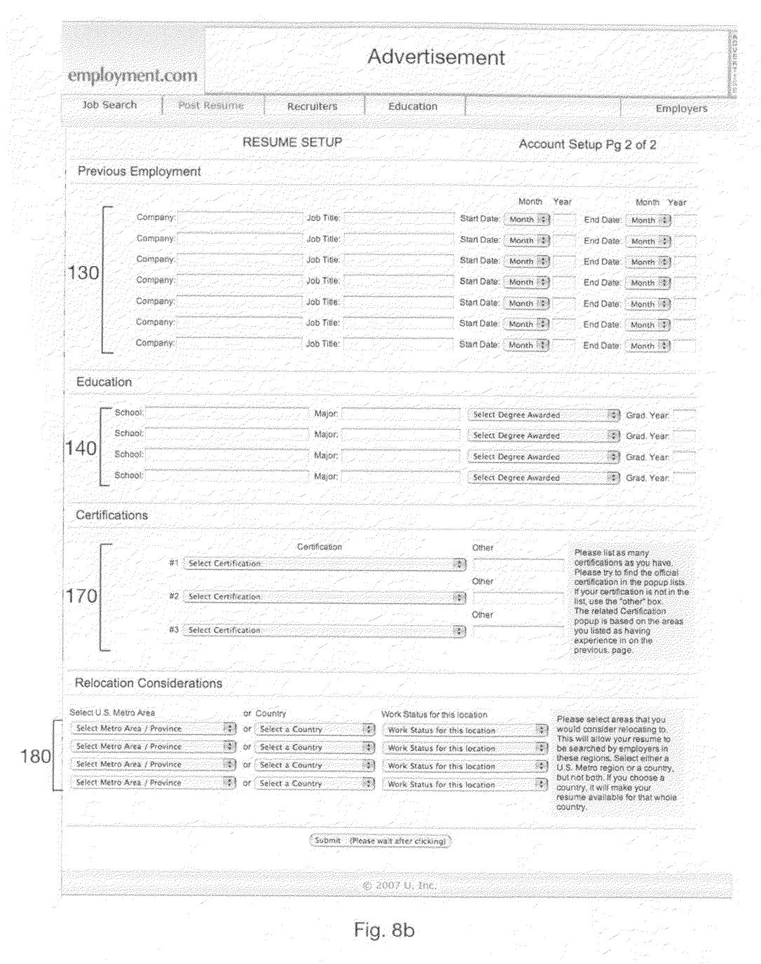

Implementation of the system and method of engaging an online employment service 1 will now be described. With continuing reference to FIG. 5, a job seeker may access the website of the present invention. The job seeker preferably clicks on the Post Resume tab. Referring now to FIG. 6, the job seeker logs in. Online employment service 1 displays the login confirmation as shown in FIG. 7. Referring now to FIGS. 8a and 8b, the job seeker preferably submits the required information in the fields labeled Personal Information 100, Experience (Years of Experience 110, Military Experience 120, and Languages 150), Employment Goals, Equal Opportunity/Affirmative ACTION/OFCCP, Receive Optional Information, Previous Employment 130, Education 140, Certifications 170 and Relocation Considerations 180. The job seeker preferably then clicks Submit and his/her résumé is posted to online employment service 1.

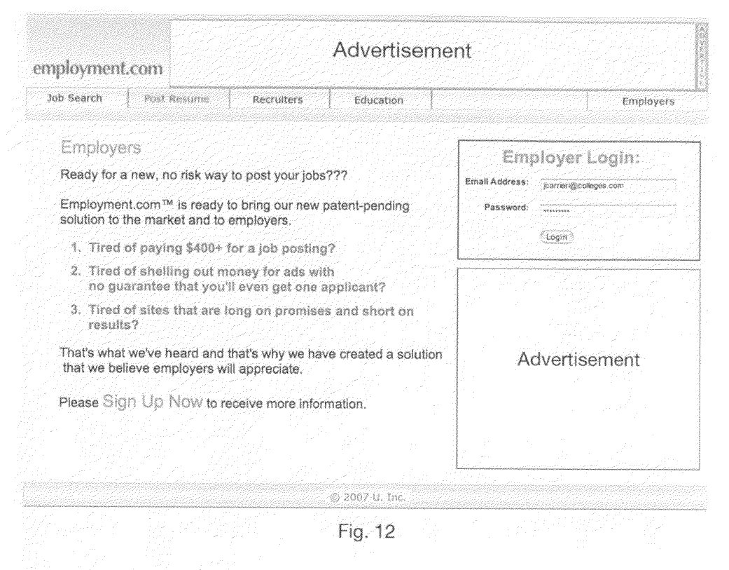

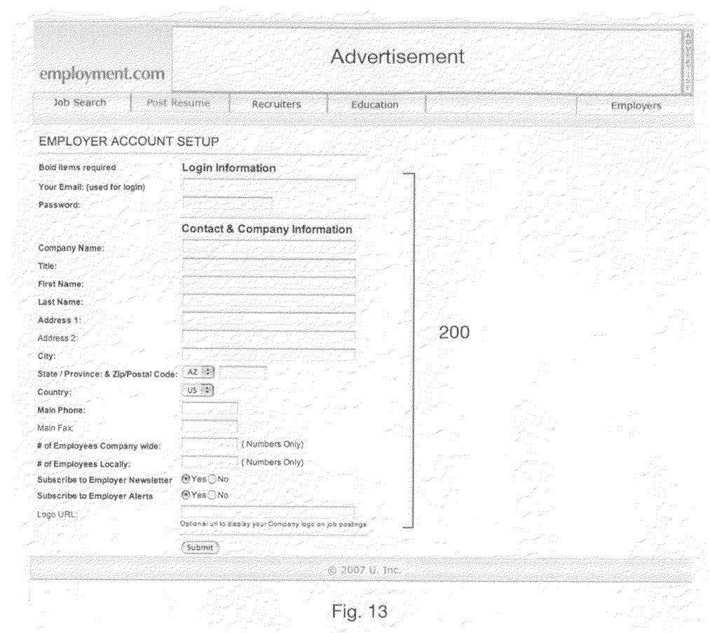

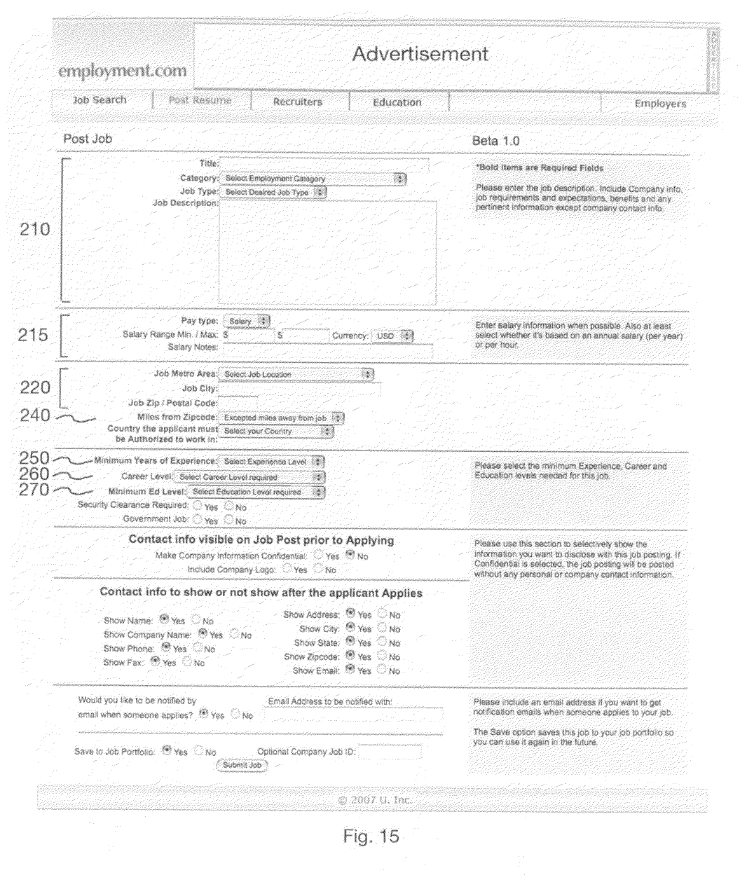

With continuing reference to FIG. 5, a prospective employer may access the website of the present invention. The employer preferably clicks on the Employers tab. Referring now to FIGS. 12 and 13, the employer logs in and preferably submits the required information for Employer Account Setup (Employer Information 200) in the fields labeled Login Information and Contact & Company Information. Online employment service 1 displays the login confirmation as shown in FIG. 14. With continuing reference to FIG. 14, the employer preferably clicks on the Post A Job button. Referring now to FIG. 15, the employer submits information in the fields for job description 210, salary information 215, job location (including Location 220 and Miles from Zipcode 240), experience 250, career level 260, education level 270, and certifications & licenses 280 (not shown), and selects the information to be posted on the job listing, as well as notification information. The employer preferably then clicks Submit Job and the job listing is posted to online employment service 1.

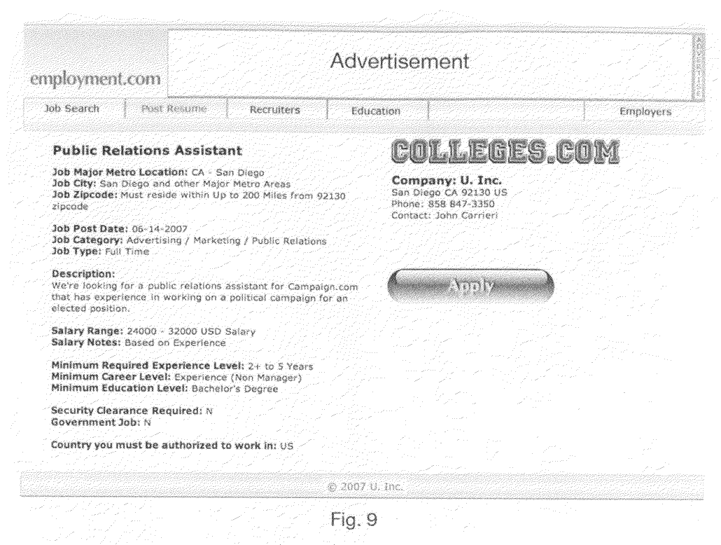

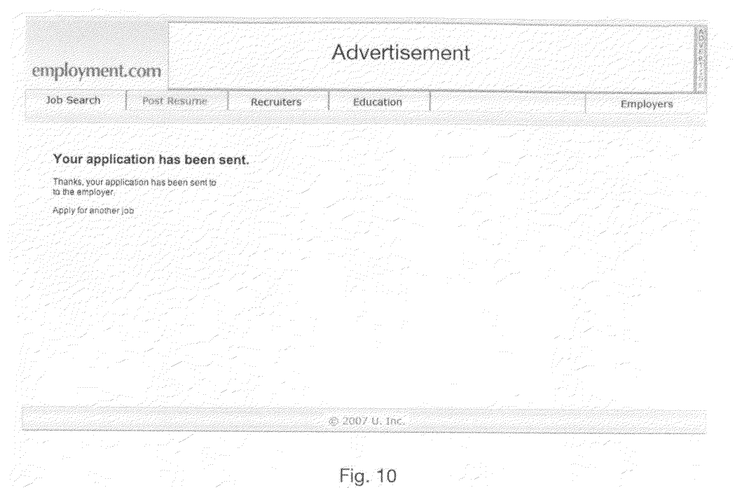

Referring back to FIG. 5, the job seeker may conduct a job search by category or location. For example, the job seeker may select PR jobs. Referring back to FIG. 3, online database management system 400 compares the job seeker to employer criteria for the selected category and displays only those jobs whose criteria are met by the job seeker. For example, as shown in FIG. 9, the job Public Relations Assistant is displayed. Database management system 400 preferably allows the job Seeker's application to pass to the employer only if the specified criteria are met. Referring again to FIGS. 2 and 3, the screening process 60 of the present invention then triggers a fee to the employer. Thus, simultaneously, applicant data 410 and charge to employer 420 are sent. Referring now to FIG. 10, the job seeker preferably is notified that his/her application has been sent. The employer may be notified by email or other means as well, if this has been specified. Referring again to FIG. 3, after the employer receives the first matched applicant information and is charged for only that applicant, a follow-up trigger 500 will allow subsequent screened, qualified and matched applicant information to be sent and charged to the employer.

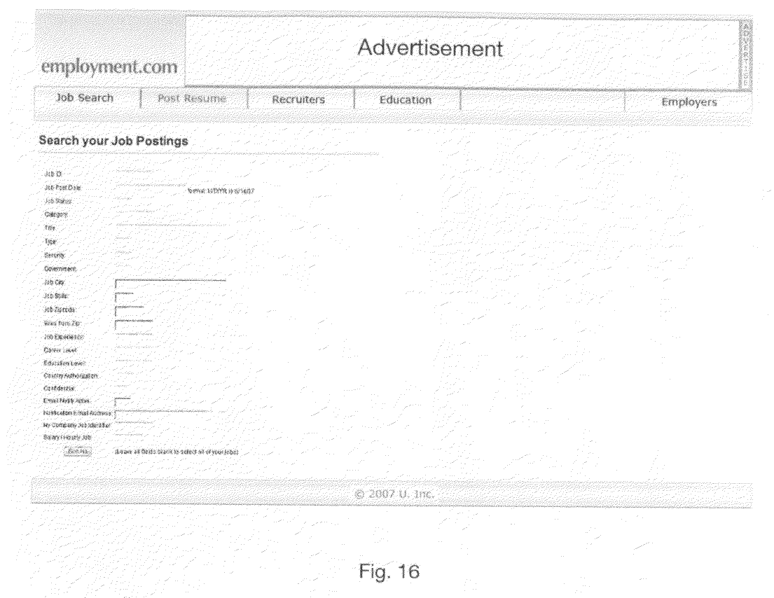

Referring back to FIG. 14, the employer may click the Job Manager button to review the posted jobs. As shown in FIG. 16, Search your Job Postings, the employer may enter one or more criteria, including Job Post Date, Job Status, Category, Title, Type, Security, Government, Job City, Job State, Job Zipcode, Miles from Zip, Job Experience, Career Level, Education Level, Country Authorization, Confidential, Email Notify Active, Notification Email Address, My Company Job Identifier and Salary/Hourly Job, in order to check the status of current jobs offered by that employer.

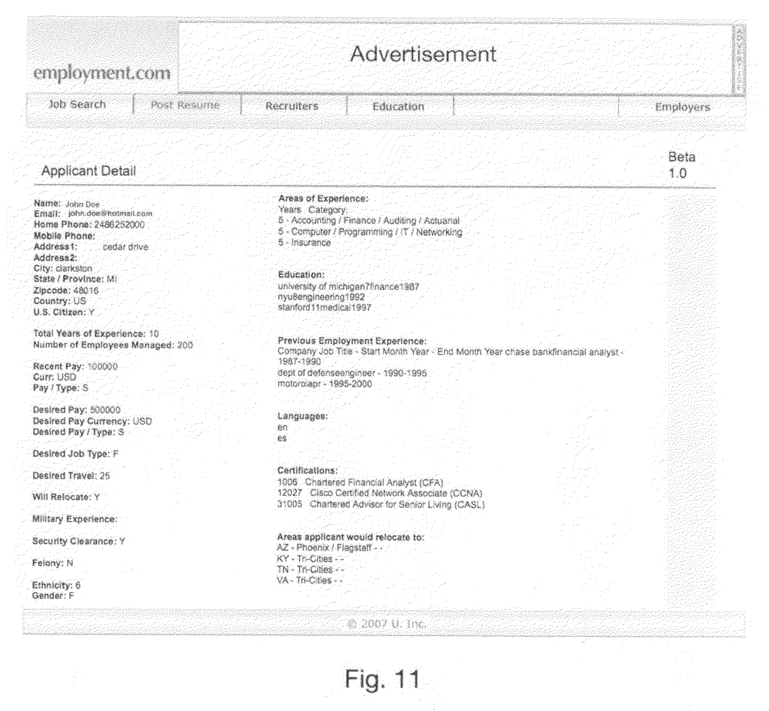

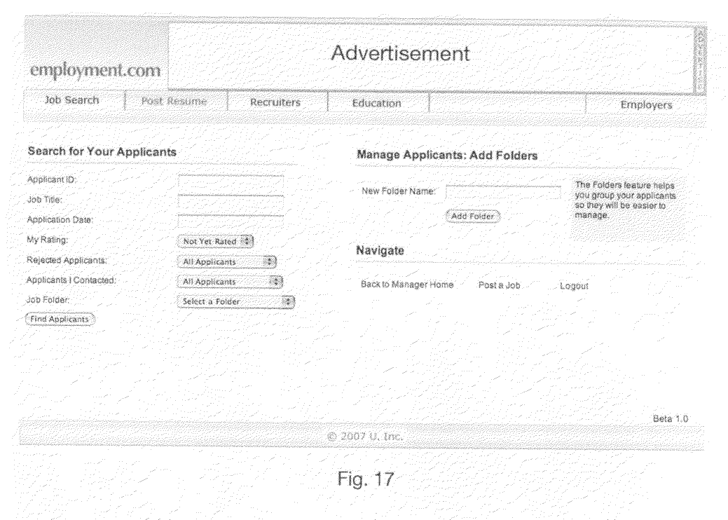

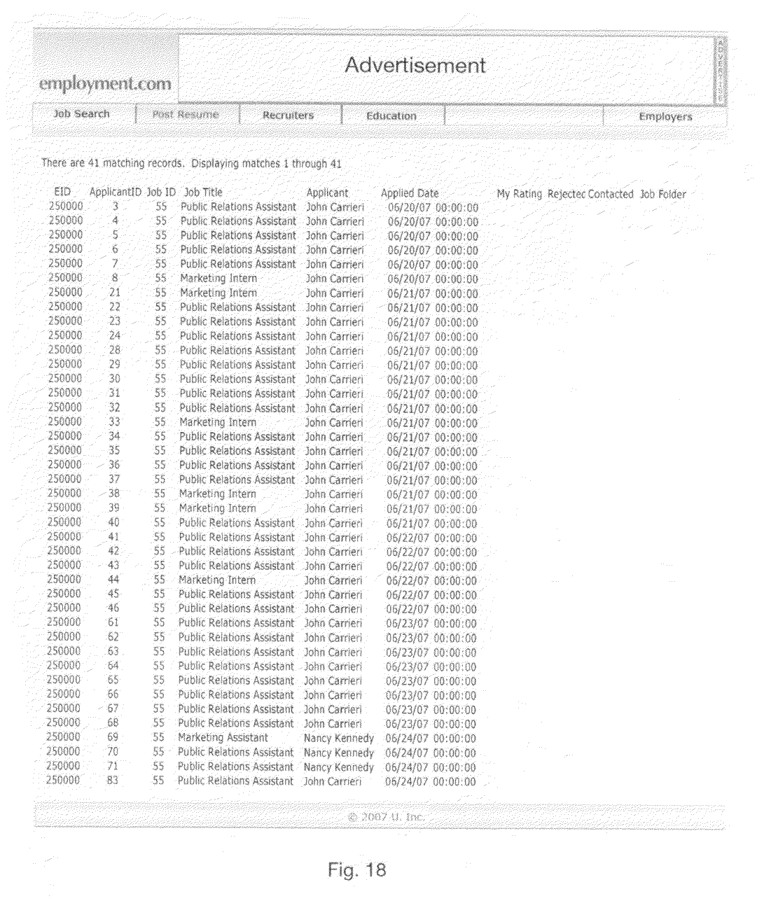

Again referring back to FIG. 14, the employer may click the Applicant Manager button to review the status of applicants for jobs offered by that employer. As shown in FIG. 17, Search for Your Applicants, the employer may review or enter applicant information, including Applicant ID, Job Title, Application Date, Rejected Applicants, Applicants Contacted and Job Folder, and may also rate an applicant. The employer may also add folders in order to group applicants and facilitate applicant management, by clicking on the Add Folder button. By clicking on the Find Applicants button, the employer brings up records of applicants for job, based on the criteria selected, as shown in FIG. 18. The employer may select a particular job/applicant record, and access detailed information about the applicant, as shown in FIG. 11.

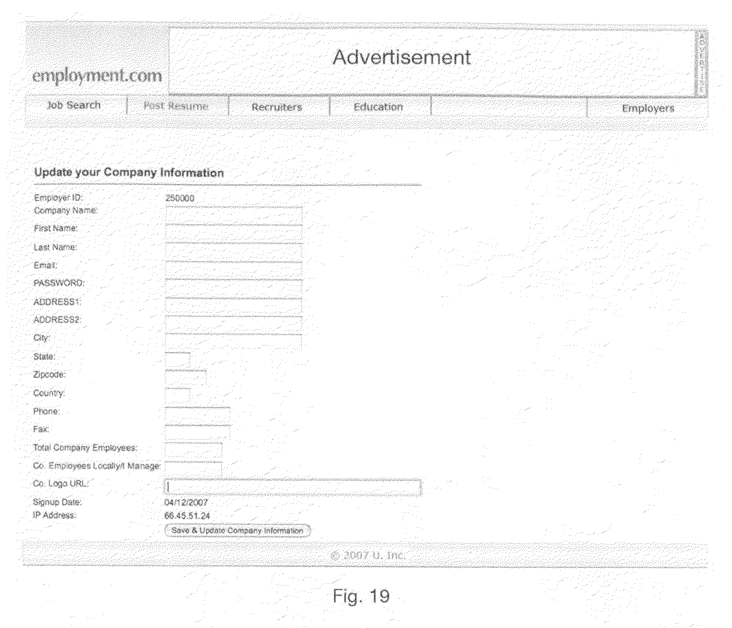

Finally, referring back to FIG. 14, the employer may click the Edit Profile button and may update the company information fields, as shown in FIG. 19.

It will be apparent to those skilled in that art that various modifications and variations can be made in the configuration of the present invention without departing from the scope and spirit of the invention. For example, screening criteria for either job seeker or employer may be added to or removed. Further, the levels within each screening criterion may be adjusted as needs dictate.

What is claimed is:

1. A computer-implemented system for engaging an online employment service, comprising a database management system that assesses at least one employee attribute from at least one prospective employee and at least one employment criterion from at least one prospective employer, wherein said database management system produces a job match when said at least one employee attribute matches said at least one employment criterion, and a screening process for triggering a fee to said at least one employer only after said job match results.

2. The computer-implemented system according to claim 1, further comprising a first online database for accepting said at least one employee attribute from said at least one prospective employee, and a second online database for accepting said at least one employment criterion from said at least one prospective employer.

3. The computer-implemented system according to claim 2, further comprising a notification system for informing said at least one prospective employee and said at least one prospective employer of said job match.

4. The computer-implemented system according to claim 3, wherein said at least one employee attribute comprises employee personal information, years of experience, military experience, previous employment, education, languages, résumé, certification and licenses, security clearances, employment goals, relocation considerations, felony convictions and work status.

5. The computer-implemented system according to claim 4, wherein said at least one employer criterion comprises employer information, job characteristics, location of job, job type, salary range, proximity to employee zip code, years of experience, career, level, education level and certification and licenses.

6. The computer-implemented system according to claim 5, wherein said screening process triggers a subsequent fee to said at least one employer after each subsequent result of said job match between said at least one employee attribute and said at least one employment criterion.

7. The computer-implemented system according to claim 6, wherein said at least one prospective employee comprises a plurality of prospective employees and said at least one prospective employer comprises a plurality of prospective employers.

8. The computer-implemented system according to claim 6, further comprising the hardware and software necessary to operate said first database for accepting said at least one employee attribute, said second database for accepting said at least one employment criterion, said database management system for assessing said at least one employee attribute and said at least one employment criterion in order to produce said job match, said screening process for triggering said fee, and said notification system for informing said at least one prospective employee and said at least one prospective employer of said job match.

9. A computer-implemented method for engaging an online employment service, comprising the steps of accepting at least one employee attribute from at least one prospective employee into a first online database, accepting at least one employment criterion from at least one prospective employer into a second online database, assessing said at least one employee attribute and said at least one employment criterion with an online database management system, producing a job match when said at least one employee attribute matches said at least one employment criterion, screening said job match so as to trigger a fee to said at least one employer only after said job match results, and notifying said at least one prospective employee and said at least one prospective employer of said job match.

10. The computer-implemented method according to claim 8, wherein said at least one employee attribute further comprises employee personal information, years of experience, military experience, previous employment, education, languages, résumé, certification and licenses, security clearances, employment goals, relocation considerations, felony convictions and work status.

11. The computer-implemented method according to claim 8, wherein said at least one employer criterion comprises employer information, job characteristics, location of job, job type, salary range, proximity to employee zip code, years of experience, career level, education level and certification and licenses.
